(19) United States
(12) Patent Application Publication
(10) Pub. No.: US 2020/0283148 A1
(43) Pub. Date: Sep. 10, 2020

(54) SPRAYING APPARATUS AND UNMANNED AERIAL VEHICLE

(71) Applicant: SZ DJI TECHNOLOGY CO., LTD., Shenzhen (CN)

(72) Inventors: Zhan SHU, Shenzhen (CN); Xiaolong WU, Shenzhen (CN); Le ZHOU, Shenzhen (CN); Jiadi WANG, Shenzhen (CN)

(21) Appl. No.: 16/882,042

(22) Filed: May 22, 2020

Related U.S. Application Data
(63) Continuation of application No. PCT/CN2017/114029, filed on Nov. 30, 2017.

(51) Int. Cl. B64D 1/18; B64C 39/02

(52) U.S. Cl. CPC B64D 1/18; B64C 2201/12; B64C 39/02

(57) ABSTRACT

A spraying apparatus includes a driving mechanism having a driving shaft rotatable around its own axis and a spin plate disposed at a bottom of the driving shaft. The spin plate is configured to rotate with the driving shaft to spray chemical solution. The driving mechanism includes a stator assembly, a rotor assembly and a housing assembly. The housing assembly includes a first housing member and a second housing member. The first housing member and the stator assembly are connected; the rotor assembly is connected to the second housing member; the first housing member is connected to the second housing member by snap-fit; and a bottom side of the second housing member is provided with a water inlet pipe that is connected to an internal of the spin plate.

### CROSS-REFERENCE TO RELATED APPLICATION

This application is a continuation of International Application No. PCT/CN2017/114029, filed Nov. 30, 2017, the entire content of which is incorporated herein by reference.

### TECHNICAL FIELD

The disclosure relates to the field of agricultural operations, in particular to a spraying apparatus and an unmanned aerial vehicle.

### BACKGROUND

With continuous development of technology, more and more automatic control equipment is used in agricultural operations.

At present, in order to spray chemical solution such as pesticides on crops, the chemical solution can be sprayed in a centrifugal manner by an automatic nozzle. Specifically, the automatic nozzle includes a rotor shaft and a spin plate that can be driven by the rotor shaft. After entering the spin plate through an internal channel, the chemical solution can be dispersed outward in a mist under the centrifugal force of the spin plate that is rotating at a high speed, to achieve a uniform spray effect. In order to supply chemical solution to the spin plate, the liquid can be introduced into the plate by a driving mechanism or from a side of the driving mechanism so that the chemical solution can flow into the spin plate from an internal space of the driving mechanism or the side of the driving mechanism.

However, due to corrosion of the chemical solution and rotation mechanism wear-out, components such as coil windings in the driving mechanisms are more likely to be damaged. When the nozzle adopts the method of introducing the chemical solution from the inside of the driving mechanism, the structure of the nozzle is more complicated. When the nozzle adopts the method of introducing the chemical solution from the side of the driving mechanism, the nozzle is usually an integrated structure and is not easy to disassemble, which causes inconvenience to disassemble the nozzle and is not conducive to repair and replacement of the nozzle.

### SUMMARY

In accordance with the disclosure, there is provided a spraying apparatus. The spraying apparatus includes a driving mechanism having a driving shaft rotatable around its own axis and a spin plate disposed at a bottom of the driving shaft. The spin plate is configured to rotate with the driving shaft to spray chemical solution. The driving mechanism includes a stator assembly, a rotor assembly and a housing assembly. The housing assembly includes a first housing member and a second housing member. The first housing member and the stator assembly are connected; the rotor assembly is connected to the second housing member; the first housing member is connected to the second housing member by snap-fit; and a bottom side of the second housing member is provided with a water inlet pipe that is connected to an internal of the spin plate.

### BRIEF DESCRIPTION OF THE DRAWINGS

In order to more clearly explain the embodiments of the present disclosure or the technical solutions in the prior art, the following will briefly introduce the drawings used in the embodiments or the description of the prior art. Obviously, the drawings in the following description are some embodiments of the present disclosure. For those of ordinary skilled in the art, other drawings can also be obtained based on these drawings without any creative efforts.

FIG. 1 is an exploded schematic view of a spraying apparatus according to an embodiment of the present disclosure;

FIG. 2 is a schematic cross-sectional view of the spraying apparatus according to an embodiment of the present disclosure;

FIG. 3 is a schematic structural diagram of a stator assembly in the spraying apparatus according to an embodiment of the present disclosure;

FIG. 4 is a schematic structural diagram of a first housing member in a spraying apparatus according to an embodiment of the present disclosure;

FIG. 5 is a schematic structural diagram of a second housing member in the spraying apparatus according to an embodiment of the present disclosure;

FIG. 6 illustrates a side view of the second housing member in the spraying apparatus according to according to an embodiment of the present disclosure;

FIG. 7 illustrates a top view of the second housing member in the spraying apparatus according to an embodiment of the present disclosure; and

FIG. 8 illustrates a cross-sectional view taken along A-A in FIG. 7.

### REFERENCE NUMERALS

1—driving mechanism; 2—spin plate; 3—mounting base; 11—stator assembly; 12—rotor assembly; 13—first housing member; 14—second housing member; 31—sleeve part; 32—thread fastener; 111—stator base; 112—winding; 121—rotor shaft; 122—rotor cover; 131—annular cavity; 132—first snap slot; 133—second protrusion; 141—hollow cavity; 142—through hole; 143—inlet channel; 144—annular cavity; 145—first protrusion; 132a—opening section; 132b—snap section; 1111—second snap slot.

### DETAILED DESCRIPTION OF THE EMBODIMENTS

To make the objectives, technical solutions, and advantages of the embodiments of the present disclosure clearer, the technical solutions in the embodiments of the present disclosure will be described clearly and completely in conjunction with the drawings in the embodiments of the present disclosure. Obviously, the described embodiments are a part of the embodiments of the present disclosure, but not all the embodiments. Based on the embodiments of the present disclosure, all other embodiments obtained by a person of ordinary skill in the art without creative efforts fall within the scope of the present disclosure.

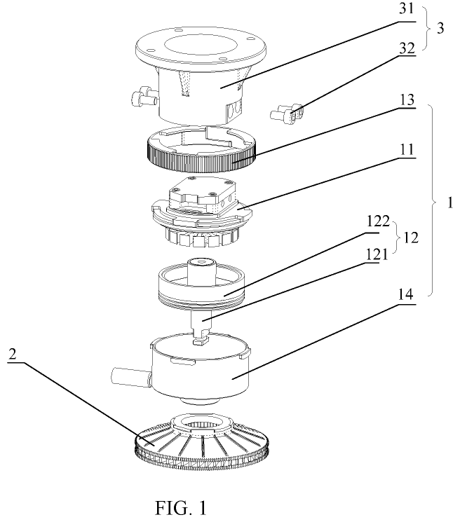

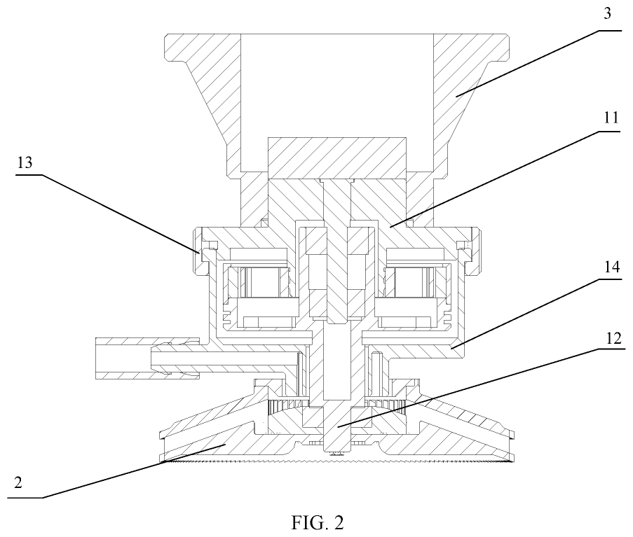

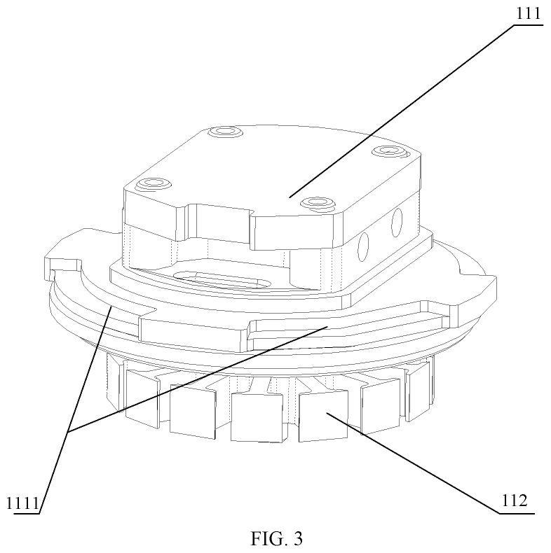

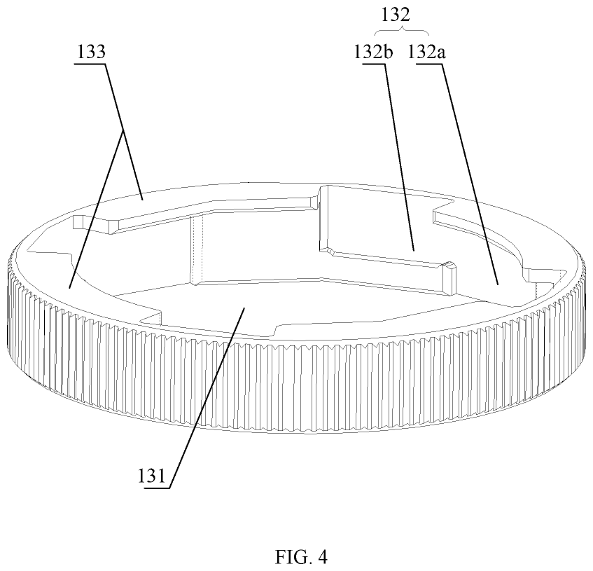

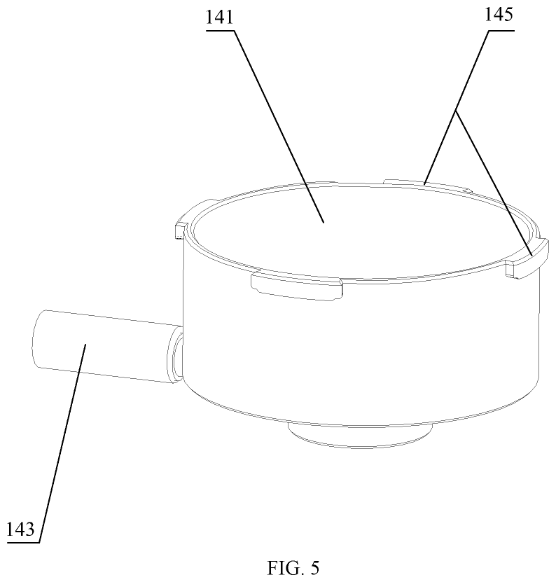

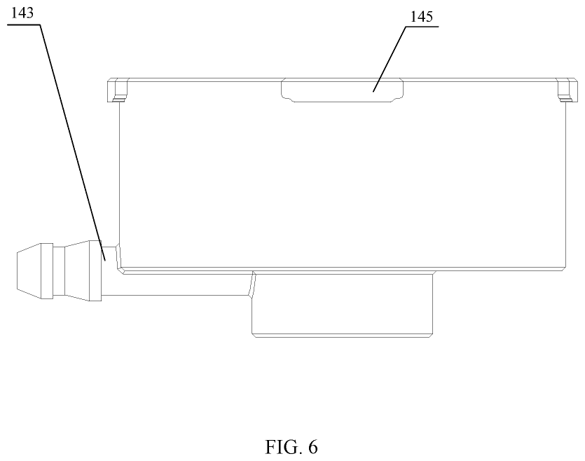

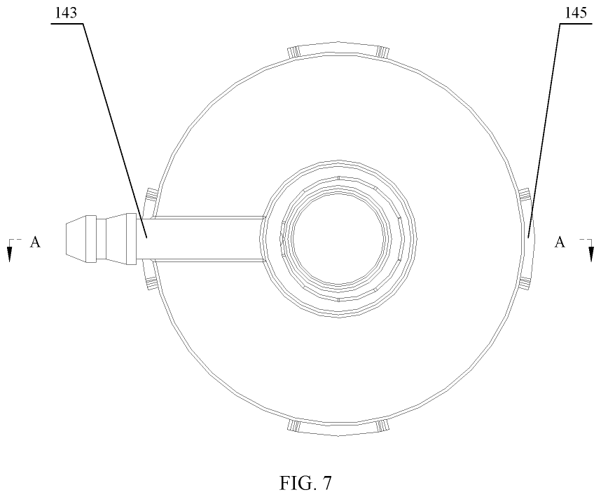

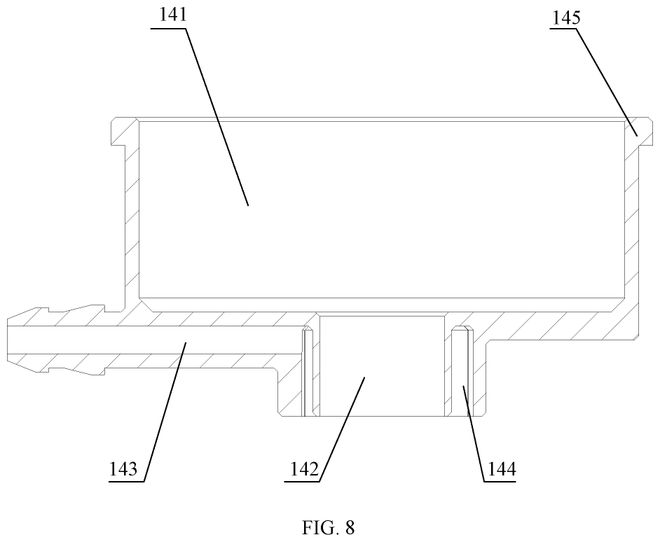

FIG. 1 is an exploded schematic view of a spraying apparatus according to an embodiment of the present disclosure. FIG. 2 is a schematic cross-sectional view of the spraying apparatus according to an embodiment of the present disclosure. FIG. 3 is a schematic structural diagram of a stator assembly in the spraying apparatus according to an embodiment of the present disclosure. FIG. 4 is a schematic structural diagram of a first housing member in a spraying apparatus according to an embodiment of the present disclosure. FIG. 5 is a schematic structural diagram of a second housing member in the spraying apparatus according to an embodiment of the present disclosure. FIG. 6 illustrates a side view of the second housing member in the spraying apparatus according to according to an embodiment of the present disclosure. FIG. 7 illustrates a top view of the second housing member in the spraying apparatus according to an embodiment of the present disclosure. FIG. 8 illustrates a cross-sectional view taken along A-A in FIG. 7. As shown in FIGS. 1 to 8, the spraying apparatus according to the embodiments of the disclosure includes a driving mechanism 1 having a driving shaft rotatable around its own axis, and a spin plate 2 disposed at a bottom of the driving shaft. The spin plate 2 is configured to be driven by the rotation shaft to rotate and spray chemical solution. The driving mechanism 1 includes a stator assembly 11, a rotor assembly 12, and a housing assembly. The housing assembly includes a first housing member 13 and a second housing member 14. The first housing member 13 is connected to the stator assembly 11. The rotor assembly 12 is received in the second housing member 14, and the first housing member 13 is connected to the second housing member 14 by a snap-fit, and a water channel connected to the spin plate 2 is disposed at a bottom side of the second housing member 14.

Specifically, the spraying apparatus is mainly configured to spray the chemical solution around uniformly by the centrifugal force during rotation, so as to achieve the purpose of uniformly spraying the chemical solution. In order to centrifuge the chemical solution, the spraying apparatus includes the driving mechanism 1 capable of driving the spin plate to rotate. The driving mechanism 1 includes a driving shaft that can rotate around its own axis. The spin plate 2 is located at the bottom of the driving shaft, so that when the driving shaft rotates, it can drive the spin plate 2 to rotate synchronously to spray the chemical solution around.

In order to drive the spin plate 2 to rotate, the driving mechanism 1 includes the stator assembly 11, the rotor assembly 12, and the housing assembly configured to fix the stator assembly 11 and the rotor assembly 12. The housing assembly is a split structure, which includes the first housing member 13 and the second housing member 14. The first housing member 13 and the second housing member 14 can be connected to the stator assembly 11 or the rotor assembly 12, respectively, and the connection the first housing member 13 and the second housing member 14 is detachable snap-fit. As such, the stator assembly 11 and the rotor assembly 12 are respectively disposed on corresponding parts of the housing assembly, so that by separating the first housing member 13 and the second housing member 14, the stator assembly 11 and the rotor assembly 12 in the driving mechanism 1 can be relatively disassembled from each other to facilitate the repair and replacement of the stator assembly 11 and the rotor assembly 12 respectively.

In order to prevent the driving mechanism from being corroded by the chemical solution, a water inlet pipe for the circulation of the chemical solution is disposed on bottom side of the second housing member 14 so that the water inlet pipe is located outside the stator assembly 11 and the rotor assembly 12. Accordingly, the chemical solution is isolated from the driving mechanism 1 and does not enter the driving mechanism 1 to cause corrosion to the driving mechanism 1. The overall corrosion resistance and reliability of the spraying apparatus are high.

Therefore, by disposing the stator assembly 11 and the rotor assembly 12 of the drive mechanism 1 on the first housing member 13 and the second housing member 14 respectively, a modular stator assembly 11 and rotor assembly 12 can be formed, to make it convenient to disassemble and install the spraying apparatus while simplifying an overall structure of the apparatus. At the same time, the water inlet pipe configured to connect the spin plate 2 is disposed at the bottom side of the housing assembly, so that the passage of the chemical solution is not connected to the internal of the driving mechanism 1, and the whole apparatus has high corrosion resistance and reliability.

In order to facilitate quick disassembly between the first housing member 13 and the second housing member 14, as an optional connection method, the first housing member 13 and the second housing member 14 can rotate to snap-in. As such, after the first housing member 13 and the second housing member 14 are being located at preset relative positions, the first housing member 13 and the second housing member 14 can rotate relative to each other to achieve the snap-fit or release of the snap-fit of the first housing member 13 and the second housing member 14. In this way, the engagement can be completed by a simple operation, and the engagement process can be relatively simple.

Generally, in the driving mechanism 1, especially the stator assembly 11 is usually provided with coil windings and other electrical components. In order to avoid the influence of the chemical solution entering the spin plate 2 through the water inlet pipe on the coil windings and so forth, the water inlet pipe may generally be located below the stator assembly 11. As such, a height of the stator assembly 11 is greater than a height of the water inlet pipe, and even if the chemical solution flows to an underneath of the stator assembly 11, it can flow downward due to gravity and cannot reach the stator assembly 11 located above, so that the stator assembly 11 cannot be corroded by the chemical solution, to increase the safety and reliability of the apparatus.

In order to dispose the stator assembly 11 and the rotor assembly 12 separately, and realize the detachable snap-fit at the same time, the first housing member 13 and the second housing member 14 in the housing assembly respectively may have a variety of possible structures and implementations. Specific illustrations are as below.

As an optional embodiment, the second housing member 14 may have a hollow cavity 141 with an open top, and the rotor assembly 12 is disposed in the hollow cavity 141. At this time, the rotor assembly 12 is occupied by the hollow cavity 141, and thus is protected by the second housing member 14. In addition, since the rotor assembly 12 is supported by the hollow cavity 141, the connection and fixation between the rotor assembly 12 and the second housing member 14 can also be implemented. A shape of the hollow cavity 141 can generally match an outer shape of the rotor assembly 12 so that the rotor assembly 12 can be steadily placed in the second housing member 14.

Optionally, the rotor assembly 12 generally includes a rotor shaft 121 and a rotor cover 122 connected to the rotor shaft 121. An axis of the rotor shaft 121 coincides with an axis of the driving shaft. The rotor shaft 121 can be connected to the spin plate 2 as a main body of the driving shaft to drive the spin plate 2 to rotate around the axis of the rotor shaft 121, and the rotor cover 122 is configured to be coupled to the stator assembly 11 to drive the rotor shaft 121 to rotate under an electromagnetic force between the stator assembly. Generally, the rotor cover 122 may surround an outside of the rotor shaft 121, a lower portion of the rotor cover 122 may be connected to the rotor shaft 121, and an upper portion of the rotor cover 122 may be spaced from the rotor shaft 121 and have an upward opening configured to receive a corresponding part of the stator assembly 11.

In addition, optionally, the rotor assembly 12 further includes at least one of a magnet and a magnetic yoke. The magnet and the magnetic yoke can generate a magnetic field force, and a power that drives the rotor assembly 12 to rotate may be generated under an action between the magnet and the stator assembly 11. Generally, the magnet and magnetic yoke in the rotor assembly 12 are usually correspondingly disposed on the rotor cover 122.

Further, in order to cause the rotor shaft 121 of the rotor assembly 12 to be easily connected to the spin plate, a through hole 142 may be disposed at the bottom surface of the second housing member 14, the rotor cover 122 may be disposed in the hollow cavity 141, and a bottom end of the rotor shaft 121 may pass through the through hole 142. In this way, the rotor shaft 121 can protrude from a bottom of the second housing member 14 and be connected to the spin plate 2 below. Since the rotor assembly 12 may rotate relative to the stator assembly 11, bearings may be disposed at a connection portion between the second housing member 14 and the rotor assembly 12 to cause the rotor assembly 12 to rotate freely relative to the second housing member 14.

Because the bottom end of the rotor shaft 121 is generally directly connected to the spin plate 2, and a hollow channel of the spin plate 2 receives the chemical solution for spraying, when the spin plate 2 is driven by the rotor shaft 121, the chemical solution may stick to an outer circumferential surface of the rotor shaft 121 due to its own viscosity, and move upwards with the rotor shaft 121, and splash into the internal of the driving mechanism 1. In order to prevent the chemical liquid from moving upward with the rotation of the rotor shaft 121, a spiral structure with the rotor shaft 121 as a rotation axis may be disposed at the outer circumferential surface of the rotor shaft 121, and a rotation direction of the spiral structure is opposite to a rotation direction of the driving shaft. Accordingly, when the chemical solution has a trend to ascend with the rotation of the rotor shaft 121, the spiral structure may block a forward path of the chemical solution, thereby preventing the chemical solution from continuing to move upward. At the same time, the chemical solution blocked by the spiral structure may also follow the spiral structure and fall to the bottom of the rotor shaft 121 in a spiral manner without being accumulated on the outer circumferential surface of the rotor shaft 121.

Generally, the spiral structure may be a spiral protrusion wound on the outer circumferential surface of the rotor shaft 121, or a spiral groove disposed on the outer circumferential surface of the rotor shaft 121. In addition, the spiral structure may also be other structure familiar to a person skilled in the art and will not be repeated here.

In order to supply the chemical solution to an internal of the spin plate 2, optionally, the second housing member 14 may be provided with a water inlet pipe 143. An inlet of the water inlet pipe 143 may be located on a side of the second housing member 14, and an outlet of the water inlet pipe 143 is located at the bottom of the second housing member 14 and has the same height with the through hole 142. The outlet and the through hole 142 are isolated from each other. Accordingly, since the outlet of the water inlet pipe 143 is located at the bottom of the second housing member 14 and is isolated from the through hole 142 and the hollow cavity 141 in the second housing member 14, so that the chemical solution can be effectively isolated from the rotor assembly 12 disposed inside the hollow cavity 141 to prevent the rotor assembly 12 from being corroded by the chemical solution.

In order to cause the chemical solution to pass through the spin plate 2 in a circumferential direction, the bottom of the second housing member 14 is also provided with a annular cavity 144 connected the outlet. The annular cavity 144 is wound around an outside of the through hole 142. Accordingly, after the chemical solution flows into the annular cavity 144 from the outlet of the water inlet pipe 143, it can fill each area in the annular cavity 144 and flow from the annular cavity 144 to all circumferential directions of the spin plate 2, so that the chemical solution can be sprayed outward in the circumferential direction of the spin plate 2.

Further, a width of the annular cavity 144 on the side close to the outlet may generally be smaller than a width on a side farther from the outlet. Accordingly, a size of the annular cavity 144 on the side near the outlet is smaller than a size on the side far from the outlet, so that the size of the annular cavity 144 may counteract the difference in flow rate caused by the different distances between itself and the outlet, so that the chemical solution can flow more uniformly to ensure that the chemical solution is evenly distributed in all circumferential directions of the spin plate 2.

In order to achieve a snap-fit with the first housing member 13, an outer periphery of the second housing member 14 may be a revolving surface, and at least one first protrusion 145 configured to snap-in the first housing member 13 is disposed at the second housing member 14. Accordingly, the second housing member 14 may be disposed inside or in the internal of the first housing member 13 and snap-in the first housing member 13 by rotation. In order to ensure uniform stress with the first housing member 13, the number of the first protrusions 145 is usually plural.

Since the first housing member 13 may receive the second housing member 14, accordingly, the first housing member 13 can have an annular cavity 131 for receiving the stator assembly 11 and the rotor assembly 12. At this time, not only the stator assembly 11 may be received in the first housing member 13 but also the rotor assembly 12 may be at least partially received inside the first housing member 13.

Further, an inner wall of the annular cavity 131 is provided with a first snap slot 132 configured to snap-in the first protrusion 145. At this time, the second housing member 14 may be received inside the annular cavity 131, and the first protrusion 145 and the first snap slot 132 may be connected to each other by snap-fit to fix the second housing member 14 to the internal of the annular cavity 131 of the first housing member 13.

In order to achieve the snap-fit connection between the first housing member 13 and the second housing member 14 in all circumferential directions, the number of the first snap slots 132 is at least two, and the first snap slots 132 and the first protrusions 145 correspond to each other. Accordingly, through the connection between the plurality of first snap slots and the first protrusions, force received by the single first protrusion 145 and the first snap slot 132 can be dispersed, while the plurality of first snap slots 132 and the first protrusions 145 distributed in different positions can receive uniform force with certainty, to avoid the phenomenon that a friction between the single first protrusion 145 and the first snap slots 132 is so great that they cannot be disassembled or even the snap-fit structure can be damaged. Generally, the first snap slot 132 and the first protrusions 145 can be arranged at even intervals around the circumference of the driving shaft.

In order to simplify the snap-in process between the first housing member 13 and the second housing member 14, the first housing member 13 and the second housing member 14 are usually connected in a rotating snap-in manner. Therefore, in order to achieve rotational engagement between the two, the first snap slot 132 is usually a rotating snap slot. As such, the first protrusion 145 can complete the entire engagement process by snapping and rotating with the first engaging slot 132, and the entire engagement process is relatively simple.

Specifically, when the first snap slot 132 is a rotating snap slot, the first snap slot 132 may include an opening section 132a opened toward the bottom of the annular cavity 131 and a snap section 132b connected to the opening section 132a. The snap section 132b extends along a circumferential direction of the annular cavity 131, and the snap section 132b is configured to snap-in the first protrusion 145 that enters the first engaging slot 132 through the opening section 132a in an axial direction of the rotor shaft 1 when the first housing member 13 and the second housing member 14 rotate relative to each other. As such, when the first protrusion 145 engages with the first snap slot 132, the first protrusion 145 can first enter the first snap slot 132 through the opening section 132a, then the first housing member 13 and the second housing member 14 may rotate relative to each other so that the first protrusion 145 moves along the snap section 132b of the first snap slot 132 to the internal of the first snap slot 132. Accordingly, the snap section 132b of the first snap slot 132 can engage with two sides of the first protrusion 145, to prevent the first protrusion 145 from detaching from the first snap slot 132, and to ensure that the first housing member 13 and the second housing member 14 are in a mutually engaged position. Generally, an engagement protrusion structure is usually disposed at the end of the snap section 132b, or a relatively large friction force exists between the end of the snap section 132b and the first protrusion 145, to prevent the first protrusion 145 from detaching from the first snap slot 132 along the snap section 132b in a reverse direction.

Optionally, in order to connect the first protrusion 145 and the first snap slot 132 to the first housing member 13 and the second housing member 14 by snap-fit in the axial direction of the driving shaft, in the first snap slot 132, an extending direction of the opening section 132a is along the axial direction of the driving shaft, and an extending direction of the snap section 132b is perpendicular to the axial direction of the driving shaft. As such, a wall of the snap section 132b can be disposed on the side of the first protrusion 145 to prevent the first housing member 13 and the second housing member 14 from being separated from each other in the axial direction of the driving shaft. Accordingly, by taking advantage of the snap-fit between the first protrusion 145 and the first snap slot 132, the second housing member 14 can be fixed on the first housing member 13 to prevent the second housing member 14 from separating from the first housing 13 in the axial direction.

Generally, a size of the opening section 132b generally matches a size of the first protrusion 145. For example, the size of the opening section 132b may be slightly larger than the size of the first protrusion 145, thereby facilitating the first protrusion 145 to enter the first snap slot 132, and meanwhile preventing the first protrusion 145 from detaching from the first snap slot 132.

Optionally, the first housing member 13 may have various shapes, for example, as an optional embodiment, the first housing member 13 may be a ring-shaped body. As such, the first housing member 13 has a relatively simple shape and a simple structure, and the cost is low.

When the first housing member 13 is a ring-shaped body, since the first housing member 13 and the second housing member 14 are usually engaged in a rotation manner, in the engagement process, the first housing member 13 and the second housing member 14 may rotate relative to each other. Accordingly, as an optional structure, the outer circumferential surface of the first housing member 13 may be provided with anti-skid patterns or anti-skid protrusions. When a user needs a rotating snap, he can conveniently hold the outer circumferential surface of the first housing member 13 so that the first housing member 13 can be engaged with the second housing member 14 or the engaged state of the two can be released.

Alternatively, in order to improve the disassembly/assembly speed and convenience of the spraying apparatus, the stator assembly 11 and the first housing member 13 are usually connected by snap-fit. The snap-fit connection enables the stator assembly 11 to be quickly and easily dissembled from the first housing member 13, thereby achieving rapid separation of the components.

Specifically, the stator assembly 11 may include a plurality of component parts such as a stator base 111. The stator base 111 may be used as a main structural component in the stator assembly 11 configured to set other components in the stator assembly 11. At this time, the stator base 111 in the stator assembly 11 and the first housing member 13 can be engaged with each other.

As one of the optional snap-fit methods, one of the first housing member 13 and the stator base 111 may be provided with a second snap slot, and the other is provided with a second protrusion that can snap in the second snap slot. Accordingly, the first housing member 13 and the stator base 111 can be connected by the snap-fit between the second protrusion and the second snap slot.

In order to reduce the volume and weight of the first housing member 13, the first housing member 13 is usually a thin-shell type component. At this time, the second protrusion 133 may be disposed on a top of the first housing member 13, and the second snap slot 1111 configured to be connected to the second protrusion 133 by snap-fit may be disposed on a periphery of the stator base 111. As such, the first housing member 13 does not need to be provided with a snap slot, so the first housing member 13 can have a thin wall, thereby effectively reducing its weight and volume. Meanwhile, because a lower part of the stator base 111 is usually provided with other components configured to be engaged with the rotor assembly 12, when the second protrusion 133 is disposed on the top of the first housing member 13, the first housing member 13 can be connected to the stator base 111 and sleeved on the lower half of the stator base 111 through the second protrusion 133, thereby effectively shielding and protecting other components on the stator base 111.

A protruding direction of the second protrusion 133 may be perpendicular to the axial direction of the rotor shaft 1. As such, the ends of the second protrusion 133 can be engaged with the second snap slot 1111 along a direction perpendicular to the axis of the rotor shaft 1. At this time, through the connection between the second protrusion 133 and the second snap slot 1111, the first housing member 13 may be hung outside the stator base 111. At the same time, the second housing member 14 may be fixed to the first housing member 13 by snap-fit, so the weight of the entire housing assembly is carried by the stator base 111.

Likewise, similar to the connection between the first protrusion 145 and the first snap slot 132, in order to cause the stator seat 111 to carry the weight of the housing assembly and the rotor assembly 12 evenly in the circumferential direction, the number of the second protrusion 133 and the second snap slot 1111 are each plural, and the second protrusions 133 and the second snap slot 1111 are evenly arranged along the circumferential direction of the rotor shaft 1. At this time, the engagement between the plurality of second protrusions and the second snap slot can effectively carry the weight of the housing assembly and the rotor assembly 12 to avoid excessive force between the single second protrusion 133 and the second snap slot 1111 that causes disassembly/assembly difficulties or the damage to the snap-fit structure.

In addition, the stator assembly 11 may include components such as windings 112 in addition to the stator base 111. The winding 112 is generally formed by a coil. When the winding 112 is energized, a directional electromagnetic field can be generated due to a shape of the winding 112, and the electromagnetic field can push the rotor assembly 12 to rotate. Generally, the winding 112 may be disposed in the lower half of the stator base 111.

Specifically, the winding 112 may be disposed at the bottom of the stator base 111, and a position of the winding 112 in the axial direction of the driving shaft corresponds to a position of the rotor assembly 12 in the axial direction of the driving shaft. At this time, the position of the winding 112 is opposite to the position of the rotor assembly 12, so that the electromagnetic field generated by the winding 112 can be just applied to the rotor assembly 12. The position of the winding 112 may be opposite to a position of the rotor cover 122 in the rotor assembly 12, and when an assembly of the rotor assembly 12 and the stator assembly 11 is completed, the winding 112 is usually be located between the rotor cover 122 and the rotor shaft 121.

In order to prevent the chemical solution from leaking to the stator assembly 11 through the gap of the housing assembly and corroding the winding 112 in the stator assembly 11 or short-circuiting the coil of the winding 112, a shielding structure may be disposed outside the winding 112. Specifically, as an optional method, a spacer may be wrapped outside the winding 112. The spacer can be sealed outside the winding 112, and can prevent external chemical solution or other liquid from penetrating the spacer and contacting the winding 112, thereby further protecting the winding from the influence of the chemical solution.

Optionally, in one implementation of the spacer, the outside of the winding 112 may be wrapped with waterproof insulation glue. The waterproof insulation glue can be sealed on the outside of the winding 112 and isolate the winding 112 from the outside, thereby achieving a waterproof sealing effect. In addition, those skilled in the art can understand that in addition to the waterproof insulation glue, the separator can also be other sealing materials that is waterproof and insulating such as a waterproof tape or a foam-like waterproof material, which will not be repeated here.

In addition, the stator assembly 11 may also include electronic speed control (ESC) and other components. The ESC may be configured to adjust a rotation speed of the rotor assembly 12 thereby controlling a spraying rate of the chemical solution sprayed by the spin plate 2. The components such as the ESC may be integrated on the stator assembly 11 to improve the compactness of the spraying apparatus on the one hand and also facilitate the modularization of the stator assembly 11 on the other hand, to achieve the disassembly and replacement of different modules.

Generally, the spraying apparatus is usually installed on other devices or systems. Accordingly, the spraying apparatus needs to be connected with other devices and structures through a connection structure. Since the housing assembly is connected to the stator assembly 11 and the rotor assembly 12 is disposed on the second housing member 14 in the housing assembly, the entire spraying apparatus is supported by the stator assembly 11. At this time, as an optional structure, the spraying apparatus may further include the mounting base 3, and the mounting base 3 and the stator assembly 11 are detachably connected. As such, the mounting base 3 can be connected to other structures as a connection member.

The mounting seat 3 may have a sleeve portion 31 with an open bottom, so that the top of the stator assembly 11 can extend into a hollow cavity of the sleeve portion 31 and be detachably connected to the mounting seat 3. The connection method between the stator assembly 11 and the mounting base 3 may be screw or snap-fit.

Since the entire spraying apparatus is connected to external structures through the mounting base 3, the connection between the stator assembly 11 and the mounting base 3 needs to bear great weight and vibration. In order to improve the connection reliability between the stator assembly 11 and the mounting base 3, the mounting seat 3 and the stator assembly 11 are connected by at least one threaded fastener 32. A threaded fastener can bear larger loads and have higher anti-vibration performance, which can effectively realize the connection between the stator assembly and the mounting seat. In this embodiment, the mounting base 3 and the stator assembly 11 are connected by four threaded fasteners 32, and the four threaded fasteners 32 are arranged opposite each other on both sides of the mounting base 3 to strengthen the connection with the threaded fastener 32.

Since the top of the stator assembly 11 extends into the hollow cavity of the sleeve portion 31, an installation direction of the threaded fastener 32 is generally perpendicular to the axial direction of the driving shaft; that is, it is connected through a side wall of the sleeve portion 31 to the stator assembly 11.

Specifically, a first mounting hole may be disposed at the wall of the sleeve portion 31, and a second mounting hole opposite to the first mounting hole may be disposed at the top of the stator assembly 11. At this time, the threaded fasteners 32 may simultaneously pass through the first mounting hole and the second mounting hole to be detachably connected to the stator assembly 11 and the mounting base 3.

In addition, the spraying apparatus also includes a swing plate 2 for spraying the chemical solution, and the swing plate 2 and the driving shaft may be detachably connected. Specifically, the connection method between the swing disk 2 and the driving shaft may be a quick release connection method such as a snap-fit.

Specifically, the spin plate 2 may be a split structure that is convenient for disassembly and maintenance. As an optional structural, the spin plate 2 may include an upper spin plate and a lower spin plate. The upper spin plate and the lower spin plate are arranged concentrically, and a passage is formed for spraying out the chemical solution between the upper spin plate and the lower spin plate. At this time, the chemical solution can enter a gap between the upper and lower spin plates and be sprayed from the passage to the surroundings of the spin plate. In order to prevent the chemical solution from being directly thrown out from a peripheral edge of the upper spin plate, the peripheral edge of the upper spin plate may be provided with a water blocking ring.

Optionally, the upper spin plate 21 and the lower spin plate 22 are provided with a water guiding groove. As such, the water guiding groove can guide the chemical solution in the gap between the upper spin plate 21 and the lower spin plate 22, so that the chemical solution can be sprayed out along the path of the water guiding groove, to improve the coverage uniformity of the spraying apparatus when spraying the chemical solution.

Specifically, in order to spray the chemical solution to the surroundings of the spin plate 2, the water guiding groove may be an arc-shaped groove arranged radially from the center of the spin plate 2 to the outer edge of the spin plate 2. When the spin plate 2 rotates, the chemical solution can be sprayed around the spin plate 2 centrifugally along the arc-shaped water guiding groove, so that there can be a high distribution and coverage range with the chemical solution.

In order to further optimize the spraying process of the chemical solution, the arc of the water guiding groove can usually be an Archimedes spiral. Accordingly, when the spin plate 2 rotates at a constant speed, the chemical solution can be evenly sprayed out with the rotation of the spin plate 2 and the coverage can be relatively uniform.

In this embodiment, the spraying apparatus includes a driving mechanism having a driving shaft rotatable around its own axis and a spin plate disposed at the bottom of the driving shaft. The spin plate is configured to rotate with the rotation of the driving shaft and spray the chemical solution. The driving mechanism includes a stator assembly, a rotor assembly and a housing assembly. The housing assembly includes a first housing member and a second housing member. The first housing member and the stator assembly are connected. The rotor assembly is connected to the second housing member, and the first housing member is connected to the second housing by snap-fit. The bottom side of the second housing component is provided with a water inlet pipe that is connected to the internal of the spin plate. Accordingly, the spraying apparatus can be easily disassembled, its structure is simple, and the isolation from the chemical solution is good.

Based on the foregoing first embodiment, the present disclosure also provides an unmanned aerial vehicle. The unmanned aerial vehicle provided in this embodiment may specifically include a body and the spraying apparatus described in the foregoing first embodiment. The structure, operation principle and effect of the spraying apparatus have been described in detail in the foregoing first embodiment, and will not be repeated here.

Specifically, the body of the unmanned aerial vehicle may include a main body, an arm, etc. The spraying apparatus is usually disposed under the main body, and the number of the spraying apparatus may be one or more to meet different spraying needs.

In this embodiment, the unmanned aerial vehicle may include a body and a spraying apparatus. The spraying apparatus may include a driving mechanism having a driving shaft rotatable around its own axis and a spin plate disposed at the bottom of the driving shaft. The driving mechanism includes a stator assembly, a rotor assembly and a housing assembly. The housing assembly includes a first housing member and a second housing member. The first housing member is connected to the stator assembly. The rotor assembly is connected to the second housing member, and the first housing member and the second housing member are connected by snap-fit. The bottom side of the second housing member is provided with a water inlet pipe that is connected to the internal of the spin plate. Accordingly, the spraying apparatus can be easily disassembled, its structure is simple, and the isolation from the chemical solution is good.

Finally, it should be noted that the above embodiments are only used to illustrate the technical solutions of the present disclosure, rather than limiting it. Although the present disclosure has been described in detail with reference to the foregoing embodiments, those of ordinary skills in the art should understand that the technical solutions described in the foregoing embodiments can still be modified, or some or all of the technical features can be equivalently substituted. Such modifications or substitutions do not cause the corresponding technical solutions to deviate from the essence of the technical range of the embodiments of the disclosure.

What is claimed is:

1. A spraying apparatus, comprising:
a driving mechanism having a driving shaft rotatable around its own axis,
a spin plate disposed at a bottom of the driving shaft, the spin plate being configured to rotate with the driving shaft to spray chemical solution, wherein:
the driving mechanism includes a stator assembly, a rotor assembly and a housing assembly, the housing assembly including a first housing member and a second housing member, the first housing member and the stator assembly being connected, the rotor assembly being connected to the second housing member, the first housing member being connected to the second housing member by snap-fit, and a bottom side of the second housing member being provided with a water inlet pipe that is connected to an internal of the spin plate.

2. The spraying apparatus according to claim 1, wherein the first housing member and the second housing member are rotatably snapped.

3. The spraying apparatus according to claim 1, wherein the water inlet pipe is located below the stator assembly.

4. The spraying apparatus according to claim 1, wherein the second housing member has a hollow cavity with an opening on top end, and the rotor assembly is disposed in the hollow cavity.

5. The spraying apparatus according to claim 4, wherein the rotor assembly comprises a rotor shaft and a rotor cover connected to the rotor shaft, an axis of the rotor shaft coinciding with an axis of the driving shaft.

6. The spraying apparatus according to claim 5, wherein: a bottom surface of the second housing member is provided with a through hole; the rotor cover is disposed in the hollow cavity; and a bottom end of the rotor shaft passes through the through hole.

7. The spraying apparatus according to claim 6, wherein an outer circumferential surface of the rotor shaft has a spiral structure having a rotation axis to be the axis of the rotor shaft, a rotation direction of the spiral structure being reverse to a rotation direction of the driving shaft.

8. The spraying apparatus according to claim 7, wherein the spiral structure is a spiral protrusion being wound on the outer circumferential surface of the rotor shaft or a spiral groove formed on the outer circumferential surface of the rotor shaft.

9. The spraying apparatus according to claim 6, wherein an inlet of the water inlet pipe is located at the side of the second housing member, an outlet of the water inlet pipe is located at the bottom of the second housing member, the outlet being at the same height as the through hole and being isolated from the through hole.

10. The spraying apparatus according to claim 9, wherein an annular cavity connected to the outlet is further disposed at the bottom of the second housing member, the annular cavity being wound around an outside of the through hole.

11. The spraying apparatus according to claim 10, wherein a width of the annular cavity on a side near the outlet is smaller than a width of a side away from the outlet.

12. The spraying apparatus according to claim 5, wherein the rotor assembly further comprises at least one of: a magnet and a magnetic yoke.

13. The spraying apparatus according to claim 4, wherein: an outer periphery of the second housing member is a revolving surface; and a side of the second housing member has at least one first protrusion configured to be engaged with the first housing member.

14. The spraying apparatus according to claim 13, wherein the first housing member has an annular cavity configured to receive the stator assembly and the rotor assembly.

15. The spraying apparatus according to claim 14, wherein an inner wall of the annular cavity has a first snap slot configured to be engaged with the first protrusion.

16. The spraying apparatus according to claim 15, wherein the number of the first snap slots is at least two, and the first snap slots correspond to the first protrusions one by one.

17. The spraying apparatus according to claim 15, wherein the first snap slot is a rotating snap slot.

18. The spraying apparatus according to claim 17, wherein the first snap slot comprises:
an opening section being opened toward a bottom of the annular cavity; and
an snap section connected to the opening section, the snap section extending along a circumferential direction of the annular cavity and being configured to be engaged with the first protrusion that enters the first snap slot from the opening section along an axial direction of the rotor shaft.

19. The spraying apparatus according to claim 18, wherein the extending direction of the opening section is an axial direction of the driving shaft, and the extending direction of the snap section is perpendicular to an axial direction of the driving shaft.

20. The spraying apparatus according to claim 18, wherein a size of the opening section matches a size of the first protrusion.
